(19) United States
(12) Patent Application Publication
(10) Pub. No.: US 2026/0047626 A1
(43) Pub. Date: Feb. 19, 2026

(54) FAN AND FAN-EQUIPPED GARMENT

(71) Applicant: SFT LABORATORY CO., LTD., Tokyo (JP)

(72) Inventors: Hiroshi ICHIGAYA, Itabashi-ku, Tokyo (JP); Hideki ICHIGAYA, Itabashi-ku, Tokyo (JP)

(73) Assignee: SFT LABORATORY CO., LTD., Tokyo (JP)

(21) Appl. No.: 19/101,840

(22) PCT Filed: Aug. 4, 2023
(86) PCT No.: PCT/JP2023/028507

§ 371 Date: Feb. 6, 2025

(30) Foreign Application Priority Data
Aug. 9, 2022 (JP) 2022-126910

(51) Int. Cl. A41D 27/28

(52) U.S. Cl. CPC A41D 27/28

(57) ABSTRACT

A fan includes a case body. The case body includes a motor case to which a motor for rotating an impeller is attached, a first case part, and a second case part that is detachably attached to the first case part. The first case part includes a cylindrical part, a flange, and an engaging tip that restricts a relative movement between the first case part and the second case part along a circumferential direction of the flange. The second case part includes an engaged part that restricts the relative movement between the first case part and the second case part. The engaging tip includes a tongue-shaped part and an engaging part that includes a protruding portion and a recessed portion. The engaged part is engaged with the engaging part and includes a recessed portion and a protruding portion.

### TECHNICAL FIELD

This invention relates to a fan and a fan-equipped garment.

### BACKGROUND ART

In recent years, a garment equipped with a fan that cools the body has been put into practical use and is rapidly becoming popular. A fan-equipped garment is made of a material with low air permeability, and a fan is attached to draw air into the garment body. When the fan is activated, a large amount of air is drawn into the body of the garment by the fan. After circulating along the surface of the wearer's body or underwear, the air is discharged to the outside through air vents disposed at openings in the collar and sleeves.

As the air drawn into the garment body by the fan circulates along the surface of the wearer's body or underwear, the air evaporates sweat from the wearer's body, thereby cooling the wearer's body by the evaporation heat generated during evaporation.

The fan used in a fan-equipped garment includes, for example, a case body that includes a built-in impeller rotated by a motor, and a rear guard attached to cover an opening of the case body. The fan is used while attached to the garment in such a manner that the case body is disposed inside the garment and the rear guard is disposed outside the garment.

A technology has been proposed to clean the inside of a fan used in such a fan-equipped garment (see, for example, Patent Document 1).

In Patent Document 1, the rear guard includes an inner cylindrical part that is in contact with a cylindrical part of the case body, and the inner cylindrical part includes an engagement claw for attaching the rear guard to the case body. At the tip of the engagement claw, a hook-shaped engaging part and an inclined portion for releasing engagement of the engagement claw engaged with the case body are disposed. The engagement of the engagement claw is released by rotating the rear guard in a predetermined direction.

### CITATION LIST

### Patent Literature

Patent Document 1: JP 2021-181755A

### SUMMARY OF INVENTION

### Technical Problem

In Patent Document 1, by relatively rotating the rear guard with respect to the case body in a predetermined direction, engagement and disengagement between a notch of the case body and the engagement claw of the rear guard part can be performed. This allows the rear guard to be detached from the case body to clean the inside of the fan. A problem is to provide a fan that allows the rear guard to be more easily detached from the case body to clean the inside of the fan.

The present invention has been made to solve such a problem, and an object of the present invention is to provide a fan that allows internal cleaning to be easily performed and a fan-equipped garment.

### Solution to Problem

In order to achieve the above object, the invention recited in claim 1 is a fan comprising a case body that includes: a motor case to which a motor for rotating an impeller is attached; a first case part; and a second case part that is detachably attached to the first case part, wherein: the first case part includes a cylindrical part, a flange that protrudes outward from an outer circumference of the cylindrical part, and an engaging means that restricts a relative movement between the first case part and the second case part along a circumferential direction of the flange; the second case part includes an engaged means that restricts the relative movement between the first case part and the second case part along the circumferential direction of the flange; the engaging means includes: a tongue-shaped part that is flexible, extends along the circumferential direction of the flange, and has one end that is a fixed end with respect to the flange and another end that is a free end; and an engaging part that is disposed at the free end of the tongue-shaped part and includes a protruding portion protruding from a surface of the flange facing the second case part and a recessed portion recessed with respect to the protruding portion, the protruding portion and the recessed portion being aligned along the circumferential direction of the flange; the engaged means includes: a recessed portion recessed with respect to a back surface of the second case part facing the flange; a protruding portion protruding with respect to the recessed portion, the protruding portion and the recessed portion being aligned along a circumferential direction of the second case part; and an engaged part that is engaged with the engaging part.

The invention recited in claim 2 is the fan according to claim 1, wherein the first case part includes a locking means that restricts a relative movement between the first case part and the second case part along an axial direction of the cylindrical part, the second case part includes a locked means that restricts the relative movement between the first case part and the second case part along the axial direction of the cylindrical part, and, when the first case part and the second case part relatively move along the circumferential direction of the flange to a position at which the engaging part is engaged with the engaged part, the locking means is locked to the locked means.

The invention recited in claim 3 is the fan according to claim 1 or 2, wherein the free end of the tongue-shaped part is disposed downstream of a direction of an engagement between the engaging part and the engaged part caused by the relative movement between the front case part and the rear case part along the circumferential direction of the flange.

The invention recited in claim 4 is the fan according to claim 1 or 2, wherein the engaging part includes a guide surface that bends the tongue-shaped part by being pressed by the engaged part, and the engaged part includes a guide surface that bends the tongue-shaped part by pressing the engaging part.

The invention recited in claim 5 is the fan according to claim 1 or 2, further comprising a mounting means that mounts the case body to a target body.

The invention recited in claim 6 is the fan according to claim 5, wherein the tongue-shaped part is exposed on a back surface of the flange and contacts the target body to which the case body is mounted by the mounting means.

The invention recited in claim 7 is a fan-equipped garment comprising: the fan according to any one of claims 1 to 6; and a garment body that covers at least a portion of a body of a wearer.

### Advantageous Effects of Invention

According to the present invention, the tongue-shaped part is easily elastically deformed by the relative movement between the first case part and the second case part along the circumferential direction of the flange. This makes it easier to detach the second case part from the first case part to perform internal cleaning.

### BRIEF DESCRIPTION OF DRAWINGS

FIG. 1 This is a rear view of a fan-equipped garment according to an embodiment when an opening and closing means is closed.

FIG. 2 This is a front view of the fan-equipped garment according to the embodiment when the opening and closing means is opened.

FIG. 3 This is an exploded perspective view of a fan according to an embodiment.

FIG. 4 This is an exploded perspective view of the fan according to the embodiment.

FIG. 5 This is a side cross-sectional view of a major portion when a front case part is attached to a rear case part.

FIG. 6A This is a side view of a major portion of the front case part illustrating an engaging tip and a locking part.

FIG. 6B This is a side cross-sectional view of a major portion of the rear case part illustrating an engaged part and an locked part.

FIG. 7A This is a perspective view of a major portion of the front case part illustrating the engaging tip and the locking part.

FIG. 7B This is a perspective view of a major portion of the rear case part illustrating the engaged part and the locked part.

FIG. 8 This is a plan view of a mounting member.

FIG. 9A This is a side cross-sectional view of a major portion illustrating an operation of detaching the rear case part from the front case part.

FIG. 9B This is a side cross-sectional view of the major portion illustrating the operation of detaching the rear case part from the front case part.

FIG. 9C This is a side cross-sectional view of the major portion illustrating the operation of detaching the rear case part from the front case part.

FIG. 10A This is a side cross-sectional view of a major portion illustrating an operation of attaching the rear case part to the front case part.

FIG. 10B This is a side cross-sectional view of the major portion illustrating the operation of attaching the rear case part to the front case part.

FIG. 10C This is a side cross-sectional view of the major portion illustrating the operation of attaching the rear case part to the front case part.

FIG. 10D This is a side cross-sectional view of the major portion illustrating the operation of attaching the rear case part to the front case part.

FIG. 10E This is a side cross-sectional view of the major portion illustrating the operation of attaching the rear case part to the front case part.

### DESCRIPTION OF EMBODIMENTS

Hereinafter, one or more embodiments of a fan and a fan-equipped garment according to the present invention will be described with reference to the drawings.

### Exemplary Configuration of Fan-Equipped Garment of Present Embodiment

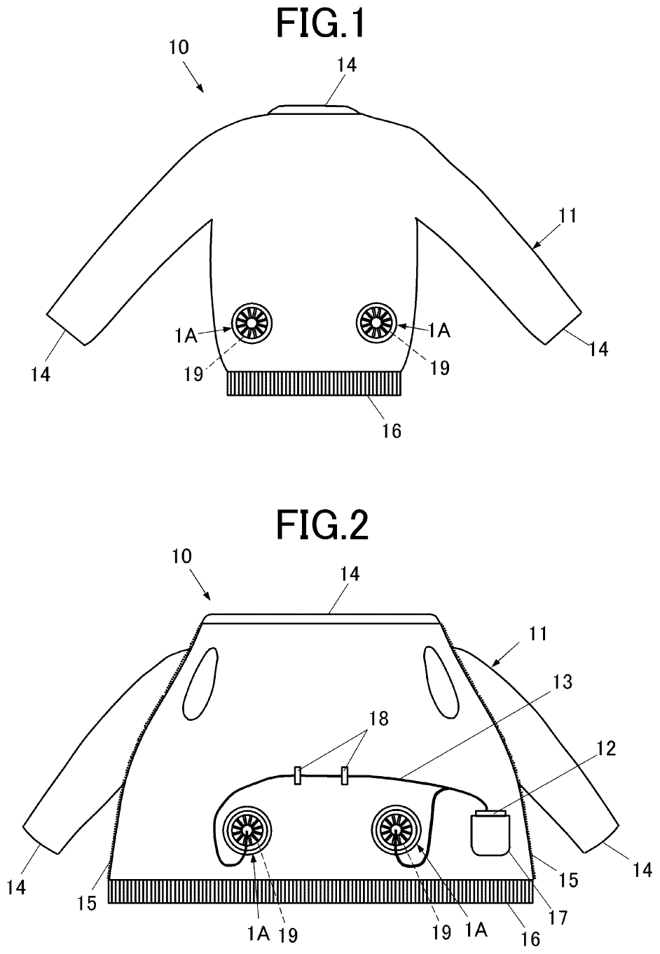

FIG. 1 is rear view of the fan-equipped garment according to an embodiment when an opening and closing means is closed. FIG. 2 is a front view of the fan-equipped garment according to the embodiment when the opening and closing means is opened.

The fan-equipped garment 10 includes a garment body 11, a fan 1A that introduces air into the garment body 11, a power supply device 12 that supplies power to the fan 1A, and a connection cable 13 that couples the power supply device 12 to the fan 1A. The fan-equipped garment 10 circulates air drawn into the garment body 11 by the fan 1A along the surface of the wearer's body or underwear and then discharges the air from air vents 14 disposed at the collar and sleeves of the garment body 11. In this way, the fan-equipped garment 10 evaporates sweat from the wearer's body, thereby cooling the wearer's body by the evaporation heat generated during evaporation.

The garment body 11 is formed into a shape that covers the wearer's torso and arms with a fabric that has no air permeability or has enough air permeability to be inflated by the introduction of air by the fan 1A. In FIGS. 1 to 3, the garment body 11 is formed into the shape of a blouson-style upper garment, but the shape of the garment body 11 is not limited thereto as long as the shape covers at least a portion of the wearer's body. For example, the garment body 11 may be formed into the shape of a vest that covers only the wearer's torso.

The front direction of the wearer is defined as the front and the back direction of the wearer is defined as the back with the wearer wearing the fan-equipped garment 10. In addition, when the wearer is wearing the fan-equipped garment 10, a side of the fan-equipped garment 10 facing the wearer is referred to as an inner side, and the opposite side of the fan-equipped garment 10 facing the outside space is referred to as an outer side.

The garment body 11 includes an opening and closing means 15 on the front side. The opening and closing means 15 is a detachable dividing portion formed with a line fastener or the like. In addition, the garment body 11 includes an air leakage preventing means 16. The air leakage preventing means 16 includes an elastic member such as a rubber string that is disposed at a hem of the garment body 11 and surrounds the wearer's body. The air leakage preventing means 16 prevents air in a space between the garment body 11 and the wearer's body from leaking to the outside from the hem of the garment body 11.

The air vents 14 are disposed at an opening between the neck of the wearer and an end portion of the collar of the garment body 11 and openings between the respective arms of the wearer and respective end portions of the corresponding sleeves of the garment body 11. Each of the air vents 14 discharges the air introduced into the space between the garment body 11 and the wearer's body by the fan 1A after the air circulates along the wearer's body or underwear.

As illustrated in FIG. 2, the inner side of the garment body 11 includes a power supply device holding means 17 and cable holding means 18. The power supply device holding means 17 is formed in a pocket shape capable of holding the power supply device 12. The power supply device holding means 17 holds the power supply device 12 at a position where power can be supplied to the fan 1A through the connection cable 13. Each of the cable holding means 18 is formed in a ring shape having an opening through which the connection cable 13 can be inserted by sewing a cloth that is long in the vertical direction at an upper position and a lower position. The cable holding means 18 holds the connection cable 13 on the inner side of the garment body 11.

As illustrated in FIGS. 1 and 2, fan attachment holes 19 are disposed at positions corresponding to the left and right sides of the wearer's waist on the back side of the garment body 11. Each of the fan attachment holes 19 is a circular hole that connects the space between the garment body 11 and the wearer's body and the space outside the garment body 11 when the fan-equipped garment 10 is worn.

The diameter of the fan attachment hole 19 is substantially the same as the diameter of a cylindrical part 22 of a case body 2 of the fan 1A described later. By attaching the fan 1A to the garment body 11 in such a manner that the cylindrical part 22 is inserted through the fan attachment hole 19, external air can be drawn into the space between the garment body 11 and the wearer's body through the fan attachment hole 19.

The periphery of the fan attachment hole 19 is preferably reinforced by a method such as attaching a flat annular member made of plastic or the like, or folding back and sewing a portion around the fan attachment hole 19 of the fabric forming the garment body 11.

### Exemplary Configuration of Fan of Present Embodiment

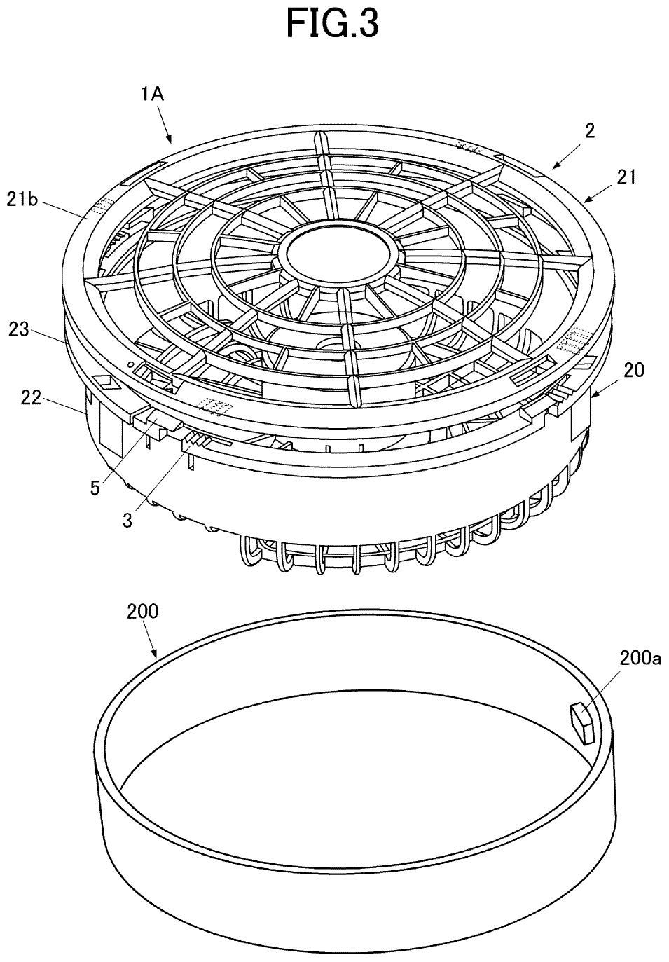

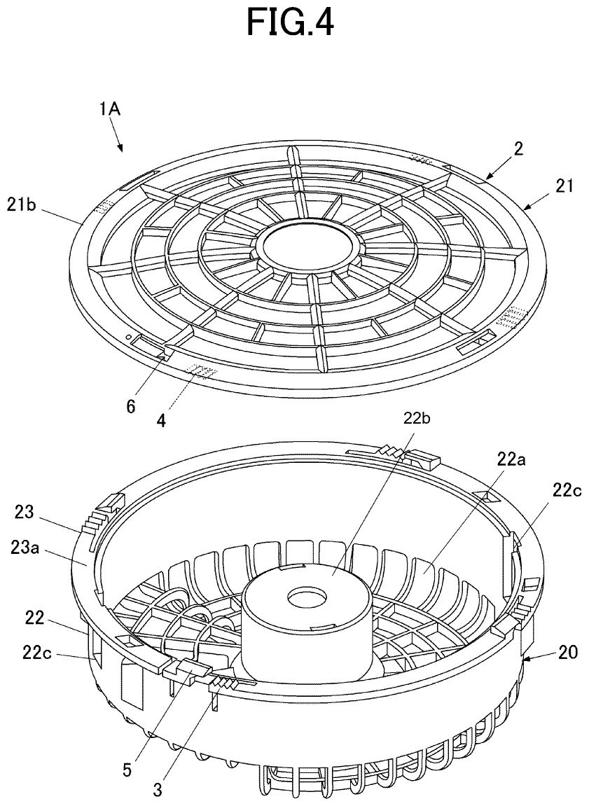

FIGS. 3 and 4 are exploded perspective views of the fan according to the embodiment. The fan 1A is a means for introducing air into the space between the garment body 11 and the wearer's body through the fan attachment hole 19 illustrated in FIG. 1. As illustrated in FIG. 2, necessary power is supplied from the power supply device 12 via the connection cable 13.

The fan 1A includes a case body 2 and a mounting member 200 that mounts the case body 2 to the garment body 11, which is an attached body.

The case body 2 is divided into two parts and includes a front case part 20 and a rear case part 21 that is detachably attached to the front case part 20. The front case part 20 and the rear case part 21 are made of resin.

The front case part 20 is an example of a first case part and includes a cylindrical part 22 and a flange 23 that protrudes outward from the outer circumference of the cylindrical part 22.

The cylindrical part 22 has a cylindrical shape and includes ventilation ports 22a through which air passes and a motor case 22b to which a motor (not shown) is attached. The ventilation ports 22a and the motor case 22b are disposed at an end portion on the front side of the cylindrical part 22, which is one end portion along the axial direction of the cylindrical shape. The flange 23 is disposed at an end portion on the back side of the cylindrical part 22, which is the other end portion along the axial direction of the cylindrical shape. The rear case part 21 is attached to the flange 23 of the front case part 20.

The ventilation ports 22a are formed by a combination of crosspieces having a predetermined shape, such as a lattice shape or a radial shape, and openings in the crosspieces. The spacing, shape, and the like of the crosspieces are set so as to allow air to pass through the ventilation ports 22a while preventing foreign matter from entering the cylindrical part 22 from the ventilation ports 22a.

The motor case 22b includes a protruding portion that is disposed at the radial center of the end portion on the front side of the cylindrical part 22 and protrudes toward the end portion on the back side. The fan 1A includes a motor (not shown) attached to the motor case 22b, and an impeller (not shown) is attached to a shaft of the motor.

The flange 23 has a shape that extends around the entire circumference in the circumferential direction and protrudes outward from the outer circumference of the end portion on the back side of the cylindrical part 22. The flange 23 includes an end surface 23a that faces the rear case part 21 when the rear case part is attached to the front case part 20. The end surface 23a is exposed at the end portion on the back side of the cylindrical part 22.

The rear case part 21 is an example of a second case part and has a disk shape that covers the end portion on the back side at which the flange 23 of the front case part 20 is disposed. The rear case part 21 includes ventilation ports 21a through which air can pass. The ventilation ports 21a are formed by a combination of crosspieces having a predetermined shape, such as a lattice shape or a radial shape, and openings in the crosspieces. The spacing, shape, and the like of the crosspieces of the ventilation ports 21a are set so as to allow air to pass through the ventilation ports 21a while preventing foreign matter from entering the cylindrical part 22 of the front case part 20 to which the rear case part 21 is attached.

The rear case part 21 includes a peripheral edge 21b that is disposed on an outer side of the ventilation ports 21 and faces the flange 23 of the front case part 20.

### Example of Attachment Structure of Front Case Part and Rear Case Part

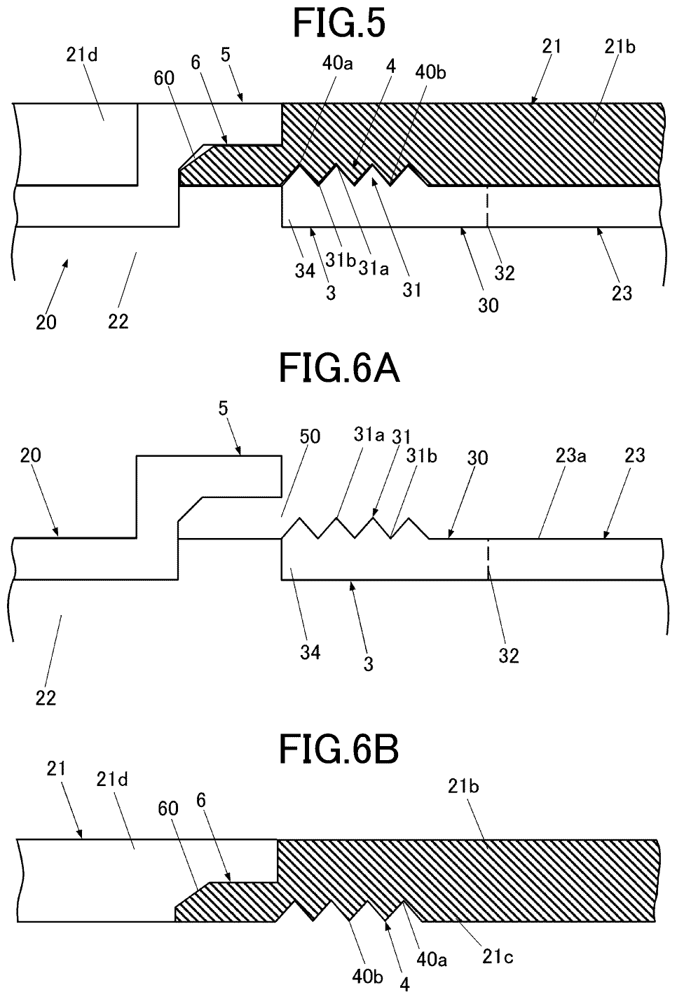

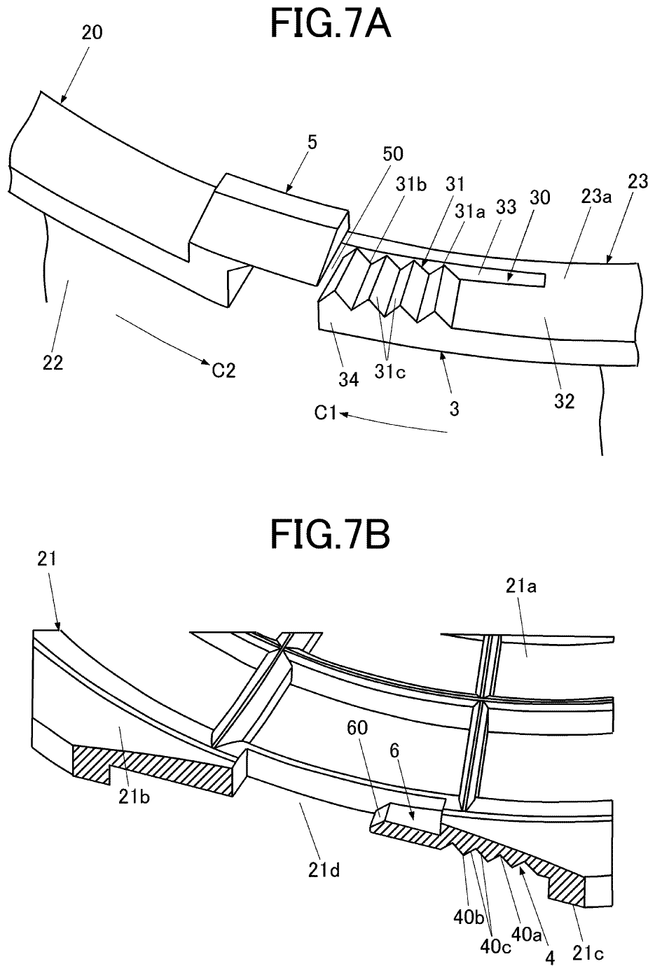

FIG. 5 is a side cross-sectional view of a major portion when a front case part is attached to a rear case part. FIG. 6A is a side view of a major portion of the front case part illustrating an engaging tip and a locking part. FIG. 6B is a side cross-sectional view of a major portion of the rear case part illustrating an engaged part and a locked part. FIG. 7A is a perspective view of a major portion of the front case part illustrating the engaging tip and the locking part. FIG. 7B is a perspective view of a major portion of the rear case part illustrating the engaged part and the locked part.

The front case part 20 includes engaging tips 3 that restrict relative movement (rotation) along the circumferential direction between the front case part 20 and the rear case part 21. The rear case part 21 includes engaged parts 4 that restrict the relative movement (rotation) along the circumferential direction between the front case part 20 and the rear case part 21.

The front case part 20 also includes locking parts 5 that restrict relative movement along the axial direction between the front case part 20 and the rear case part 21. The rear case part 21 also includes locked parts 6 that restrict the relative movement along the axial direction between the front case part 20 and the rear case part 21.

In the present example, the engaging tips 3 are disposed at four positions along the circumferential direction of the flange 23 of the front case part 20. The engaged parts 4 are disposed at four positions along the circumferential direction of the peripheral edge 21b of the rear case part 21 corresponding to the positions of the engaging tips 3. The locking parts 5 are disposed adjacent to the respective engaging tips 3 at four positions along the circumferential direction of the flange 23 of the front case part 20. The locked parts 6 are disposed adjacent to the respective engaged parts 4 at four positions along the circumferential direction of the peripheral edge 21b of the rear case part 21 corresponding to the positions of the locking parts 5.

Each of the engaging tips 3 is an example of an engaging means. The engaging tip includes a tongue-shaped part 30 extending along the circumferential direction of the flange 23, and an engaging part 31 disposed at an end portion of the tongue-shaped part 30 in the extending direction. In the engaging tip 3, the tongue-shaped part 30 and the engaging part 31 are integrally formed with the flange 23, and one end portion of the tongue-shaped part 30 is connected to the flange 23. Accordingly, in the engaging tip 3, a base end portion of the tongue-shaped part 30 connected to the flange 23 serves as a fixed end 32 with respect to the flange 23.

Further, the engaging tip 3 has a slit 33 disposed between the tongue-shaped part 30 and the cylindrical part 22, along the circumferential direction of the flange 23, from the fixed end 32 of the tongue-shaped part 30 toward the other end portion of the tongue-shaped part 30 in the extending direction. Accordingly, in the engaging tip 3, the end portion of the tongue-shaped part 30 in the extending direction serves as a free end 34.

As described above, the front case part 20 is made of resin, and the engaging tip 3 is configured such that the tongue-shaped part 30 can be bent by elastic deformation in the thickness direction of the flange 23.

The engaging part 31 is disposed on the side of the free end 34 of the tongue-shaped part 30. The engaging part 31 has an uneven shape in which a plurality of protruding portions 31a protruding from the end surface 23a of the flange 23 and a plurality of recessed portions 31b recessed with respect to the protruding portions 31a are aligned along the circumferential direction of the flange 23. In the engaging part 31, a cross-sectional shape of the protruding portions 31a is a triangle, and a cross-sectional shape of the recessed portions 31b is an inverted triangle. The engaging part 31 includes guide surfaces 31c that bend the tongue-shaped part 30 by inclined surfaces of the protruding portions 31a and inclined surfaces of the recessed portions 31b both pressed by the engaged part 4.

In the engaging tip 3, the tongue-shaped part 30 extends from the fixed end 32 in a clockwise direction indicated by an arrow C1 when the front case part 20 is viewed from the side facing the flange 23, and the engaging part 31 is disposed at the free end 34, which is the end portion of the tongue-shaped part 30 in the extending direction.

Accordingly, in the engaging tip 3, when the tongue-shaped part 30 is bent by elastic deformation in the thickness direction of the flange 23, the protruding portions 31a of the engaging part 31 are displaced from an engaging position at which the protruding portions 31a of the engaging part 31 protrude from the end surface 23a of the flange 23 to a retracted position at which the protruding portions 31a of the engaging part 31 are substantially at the same level as the end surface 23a of the flange 23. The engaging tip 3 is configured such that the back surface of the tongue-shaped part 30 is substantially flush with the back surface of the end surface 23a of the flange 23 when the protruding portions 31a of the engaging part 31 are at the engaging position protruding from the end surface 23a of the flange 23.

Each of the engaged parts 4 is an example of an engaged means. The engaged part is disposed on the back surface 21c of the peripheral edge 21b of the rear case part 21 facing the flange 23 of the front case part 20 when the rear case part 21 is attached to the front case part 20.

The engaged part 4 has an uneven shape in which a plurality of recessed portions 40a recessed with respect to the back surface 21c of the peripheral edge 21b and a plurality of protruding portions 40b protruding with respect to the recessed portions 40a are aligned along the circumferential direction of the peripheral edge 21b. In the engaged part 4, a cross-sectional shape of the recessed portions 40a is an inverted triangle, a cross-sectional shape of the protruding portions 40b is a triangle, and the uneven shape of the engaged part 4 coincides with the uneven shape of the engaging part 31 of the front case part 20. The engaged part 4 includes guide surfaces 40c that bend the tongue-shaped part 30 by inclined surfaces of the recessed portions 40a and inclined surfaces of the protruding portions 40b both pressing the engaging part 31 of the engaging tip 3.

Each of the locking parts 5 is an example of a locking means and protrudes in an inverted L shape from the end surface 23a of the flange 23. The locking part 5 extends in a counterclockwise direction indicated by an arrow C2 when the front case part 20 is viewed from the side facing the flange 23. The locking part 5 has an opening 50 disposed between the locking part 5 and the engaging part 31 of the engaging tip 3.

Each of the locked parts 6 is an example of a locked means and protrudes from the engaged part 4 along the circumferential direction of the peripheral edge 21b. The locked part 6 has a thickness approximately equal to a gap between the locking part 5 and the end surface 23a of the flange 23. When the rear case part 21 is attached to the front case part 20, the locked part 6 is inserted into the gap between the locking part 5 and the end surface 23a of the flange 23 through the opening 50 between the locking part 5 and the engaging tip 3.

The locked part 6 includes a guide portion 60. The guide portion 60 includes an inclined surface at a tip of the locked part 6 that comes into contact with the locking part 5 when the rear case part 21 is attached to the front case part 20.

The rear case part 21 has a locking part actuation space 21d in which the locking part 5 of the front case part 20 can move when the rear case part 21 is attached to the front case part 20. The locking part actuation space 21d has an opening that extends from the locked part 6 along the circumferential direction of the peripheral edge 21b.

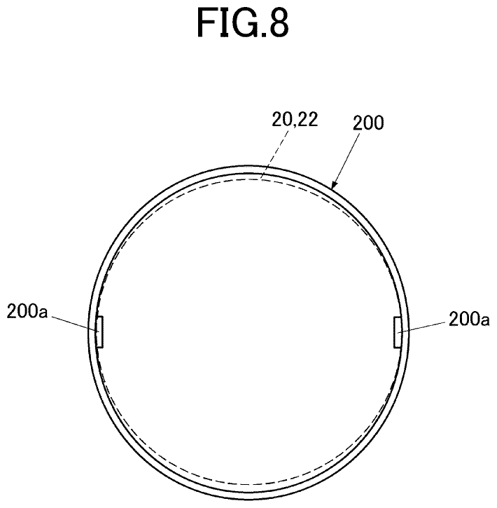

FIG. 8 is a plan view of a mounting member, and the mounting member 200 will be described next. The mounting member 200 is an example of a mounting means and has an elliptical shape when viewed from the axial direction. The mounting member 200 includes protrusions 200a at two predetermined positions facing each other in the minor axis direction of the mounting member 200. The inner diameter of the mounting member 200 in the minor axis direction is approximately equal to the outer diameter of the cylindrical part 22 of the front case part 20 indicated by a broken line in FIG. 8. The mounting member 200 is integrally formed of resin and is flexible.

As illustrated in FIG. 4, the fan 1A includes fitting recesses 22c disposed in the cylindrical part 22 of the front case part 20. The fitting recesses 22c are disposed according to the positions of the pair of protrusions 200a of the mounting member 200, and the protrusions 200a are fitted into the fitting recesses 22c.

To attach the mounting member 200 to the fan 1A, portions of the mounting member 200 facing each other in the major axis direction are pressed from both sides. When the portions of the mounting member 200 facing each other in the major axis direction are pressed from both sides, portions of the mounting member 200 in the minor axis direction bulge outward. This allows the mounting member 200 to be deformed into a substantially circular shape. At this time, the distance between the pair of protrusions 200a of the mounting member 200 becomes slightly larger than the outer diameter of the cylindrical part 22 of the front case part 20. Thus, the cylindrical part 22 of the front case part 20 can be inserted into the mounting member 200.

Then, when the pressing force is released while the positions of the protrusions 200a of the mounting member 200 are aligned with the positions of the fitting recesses 22c of the cylindrical part 22, the mounting member 200 returns to its original shape and the protrusions 200a of the mounting member 200 are fitted into the fitting recesses 22c of the cylindrical part 22.

The mounting member 200 is attached so as to cover the outer peripheral surface of the cylindrical part 22 of the front case part 20. As a result, an end surface of the mounting member 200 faces the back surface of the flange 23. The fan 1A is attached to the garment body 11 in such a manner that the cylindrical part 22 is inserted through the fan attachment hole 19 illustrated in FIGS. 1 and 2. This causes a peripheral edge of the fan attachment hole 19 to be sandwiched between the end surface of the mounting member 200 and the back surface of the flange 23.

### Example of Attachment/Detachment Operation of Front Case Part and Rear Case Part

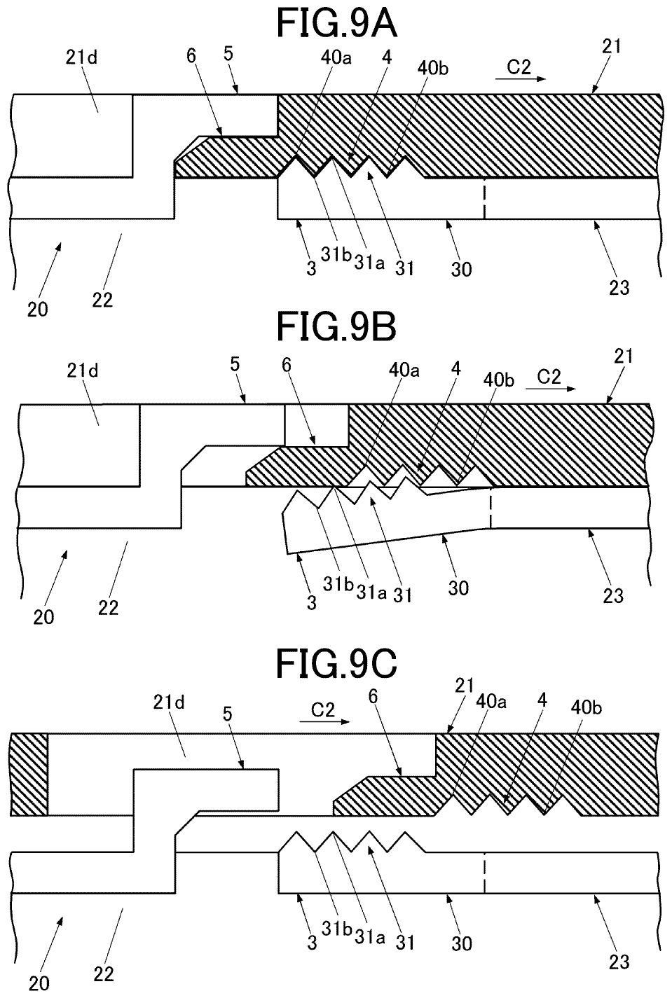

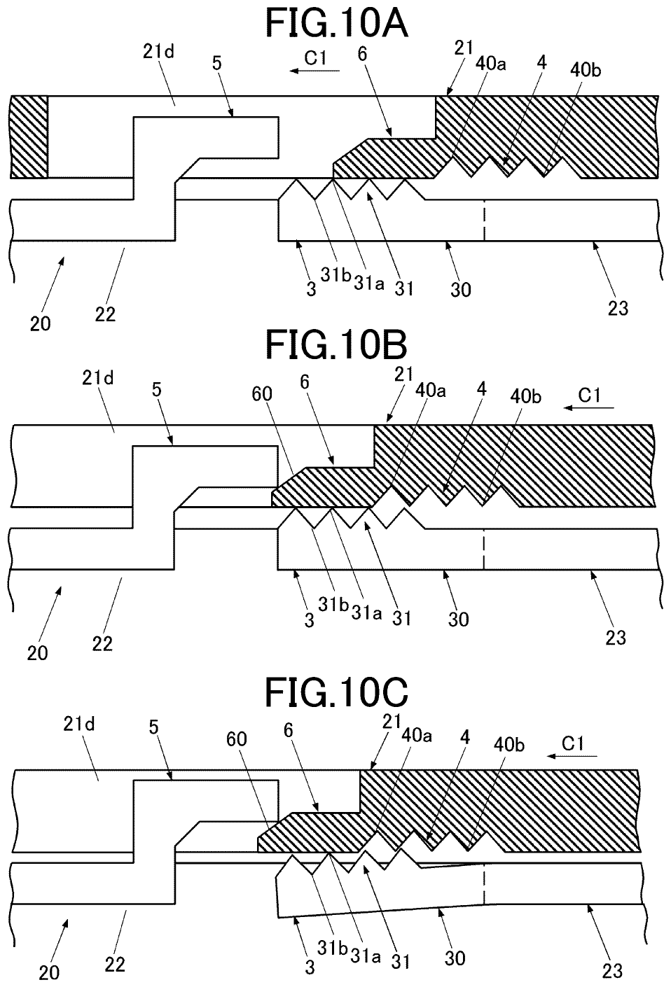

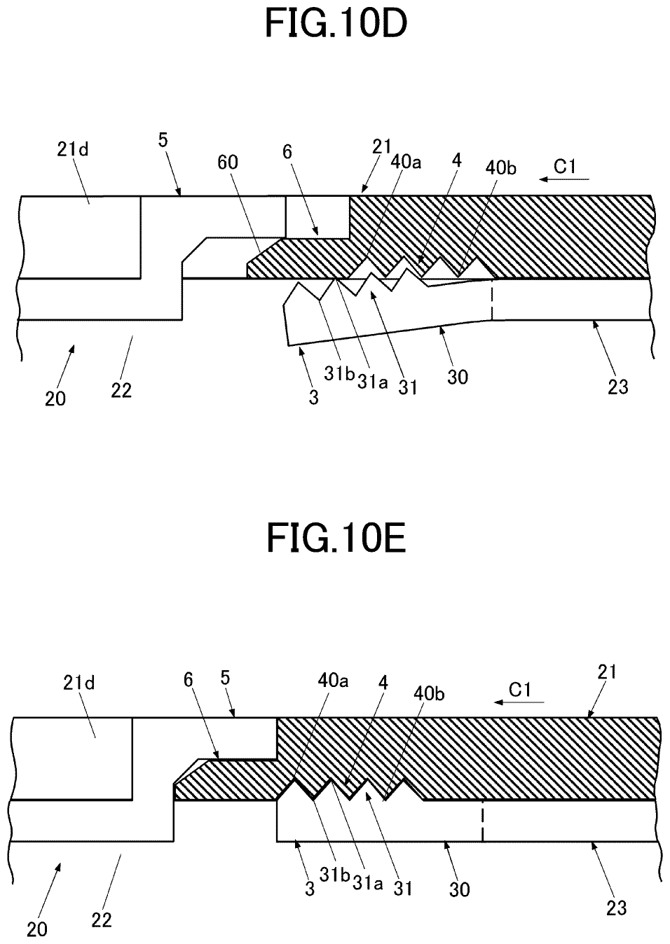

FIGS. 9A, 9B, and 9C are side cross-sectional views of major portions illustrating an operation of detaching the rear case part from the front case part. FIGS. 10A, 10B, 10C, 10D, and 10E are side cross-sectional views of major portions illustrating an operation of attaching the rear case part to the front case part.

To detach the rear case part 21 from the front case part 20, as illustrated in FIG. 9A, a force is applied to rotate the rear case part 21 in the counterclockwise direction indicated by the arrow C2 with respect to the front case part 20

In the engaging part 31 of the engaging tip 3 of the front case part 20 and the engaged part 4 of the rear case part 21, the protruding portions 31a and recessed portions 31b of the engaged part 31 are in contact with the respective recessed portions 40a and protruding portions 40b of the engaged part 4 at the guide surfaces 31c and 40c inclined with respect to the direction of rotation of the rear case part 21 with respect to the front case part 20.

Accordingly, when a force is applied to rotate the rear case part 21 in the counterclockwise direction indicated by the arrow C2 with respect to the front case part 20, a force is generated such that the engaged part 4 of the rear case part 21 presses the engaging part 31 of the engaging tip 3 of the front case part 20 in the axial direction of the cylindrical part 22.

Therefore, in the engaging tip 3, as illustrated in FIG. 9B, the tongue-shaped part 30 is bent in a direction in which the engaging part 31 is retracted from the engaged part 4, and the engagement between the engaging part 31 of the engaging tip 3 and the engaged part 4 is released. This allows the rear case part 21 to be rotated in the counterclockwise direction indicated by the arrow C2 with respect to the front case part 20.

When the rear case part 21 is further rotated in the counterclockwise direction indicated by the arrow C2 with respect to the front case part 20, as illustrated in FIG. 9C, the locked part 6 of the rear case part 21 is disengaged from the locking part 5 of the front case part 20. This allows the rear case part 21 to be detached from the front case part 20.

To attach the rear case part 21 to the front case part 20, as illustrated in FIG. 10A, the locking part 5 of the front case part 20 is inserted into the locking part actuation space 21d of the rear case part 21, and the rear case part 21 is rotated in the clockwise direction indicated by the arrow C1 with respect to the front case part 20.

When the rear case part 21 is rotated in the clockwise direction indicated by the arrow C1 with respect to the front case part 20, as illustrated in FIG. 10B, the locked part 6 of the rear case part 21 is inserted into the opening 50 between the locking part 5 of the front case part 20 and the engaging tip 3, and the guide portion 60 of the locked part 6 comes into contact with the locking part 5. Since the locked part 6 and the locking part 5 are in contact with each other at the inclined surface of the guide portion 60, when the rear case part 21 is rotated in the clockwise direction indicated by the arrow C1 with respect to the front case part 20, a force is generated such that the locked part 6 and the engaged part 4 of the rear case part 21 press the engaging parts 31 of the engaging tip 3 of the front case part 20 in the axial direction of the cylindrical part 22.

Therefore, in the engaging tip 3, as illustrated in FIG. 10C, the tongue-shaped part 30 is bent in the direction in which the engaging part 31 is retracted from the engaged part 4. This allows the rear case part 21 to be rotated in the clockwise direction indicated by the arrow C1 with respect to the front case part 20. When the rear case part 21 is further rotated in the clockwise direction indicated by the arrow C1 with respect to the front case part 20, through the contact between the locked part 6 and the locking part 5 at the inclined surface of the guide portion 60, the rear case part 21 is moved toward the front case part 20, and as illustrated in FIG. 10D, the locked part 6 of the rear case part 21 is inserted between the locking part 5 of the front case part 20 and the flange 23.

When the rear case part 21 is further rotated in the clockwise direction indicated by the arrow C1 with respect to the front case part 20 while the locked part 6 of the rear case part 21 is inserted between the locking part 5 of the front case part 20 and the flange 23, the positions of the protruding portions 31a of the engaging part 31 of the engaging tip 3 of the front case part 20 are aligned with the positions of the recessed portions 40a of the engaged part 4 of the rear case part 21, and the positions of the recessed portions 31b of the engaging part 31 of the engaging tip 3 of the front case part 20 are aligned with the protruding portions 40b of the engaged part 4 of the rear case part 21.

As a result, in the engaging tip 3, the tongue-shaped part 30 is elastically restored in a direction in which the engaging part 31 approaches the engaged part 4. Then, as illustrated in FIG. 10E, the protruding portions 31a of the engaging part 31 are fitted into the recessed portions 40a of the engaged part 4, and the recessed portions 31b of the engaging part 31 are fitted into the protruding portions 40b of the engaged part 4, causing the engaging part 31 of the engaging tip 3 to be engaged with the engaged part 4.

Thus, the rear case part 21 is attached to the front case part 20 while the relative movement (rotation) between the front case part 20 and the rear case part 21 along the circumferential direction of the flange 23 is restricted. In addition, by having the locked part 6 of the rear case part 21 inserted between the locking part 5 of the front case part 20 and the flange 23, the locked part 6 is locked to the locking part 5. Thus, the rear case part 21 is attached to the front case part 20 while the relative movement between the front case part 20 and the rear case part 21 along the axial direction is restricted.

The tongue-shaped part 30 of the engaging tip 3 extends in the circumferential direction of the flange 23. This makes it easier for the tongue-shaped part 30 to be elastically deformed by the relative movement (rotation) between the front case part 20 and the rear case part 21 along the circumferential direction of the flange 23. However, it is necessary to prevent unintentional release of the engagement between the engaging part 31 of the front case part 20 and the engaged part 4 of the rear case part 21.

Therefore, the tongue-shaped part 30 of the engaging tip 3 extends from the fixed end 32 in the clockwise direction indicated by the arrow C1 when the front case part 20 is viewed from the side facing the flange 23. In the tongue-shaped part 30, the free end 34 is disposed downstream of a direction of the engagement between the engaging part 31 of the engaging tip 3 and the engaged part 4 caused by the relative movement (rotation) between the front case part 20 and the rear case part 21 along the circumferential direction of the flange 23. The engaging part 31 is disposed at the free end 34, which is the end portion of the tongue-shaped part 30 in the extending direction.

Accordingly, the tongue-shaped part 30 can be elastically deformed more easily when the rear case part 21 is rotated in the clockwise direction indicated by the arrow C1 with respect to the front case part 20 in order to attach the rear case part 21 to the front case part 20 than when the rear case part 21 is rotated in the counterclockwise direction indicated by the arrow C2 with respect to the front case part 20 in order to detach the rear case part 21 from the front case part 20.

This allows internal cleaning of the fan 1A to be easily performed by detaching the rear case part 21 from the front case part 20 while preventing unintentional release of the engagement between the engaging part 31 of the front case part 20 and the engaged part 4 of the rear case part 21.

While the fan 1A is attached to the garment body 11, the peripheral edge of the fan attachment hole 19 is sandwiched between the end surface of the mounting member 200 and the back surface of the flange 23, and the tongue-shaped part 30 of the engaging tip 3 exposed on the back surface of the flange 23 contacts the peripheral edge of the fan mounting hole 19. Accordingly, when the rear case part 21 is rotated in the counterclockwise direction with respect to the front case part 20 to detach the rear case part 21 from the front case part 20 while the fan 1A is attached to the garment body 11, the tongue-shaped part 30 of the engaging tip 3 is prevented from being bent by the peripheral edge of the fan attachment hole 19.

This suppresses detachment of the rear case part 21 from the front case part 20 while the fan 1A is attached to the garment body 11 and prevents the rear case part 21 from coming off the front case part 20 while power can be supplied to the fan 1A.

In the present example, the engaging tips 3 and the locking parts 5 are disposed at four positions along the circumferential direction of the flange 23 of the front case part 20, and the engaged parts 4 and the locked parts 6 are disposed at four positions along circumferential direction of the peripheral edge 21b of the rear case part 21, but the number of these parts is not limited thereto. Further, among the plurality of pairs of the engaging tip 3 and the locking part 5, only the locking part 5 without the paired engaging tip 3 may be disposed at one or two positions, and for the corresponding pair of the engaged part 4 and the locked part 6, only the locked part 6 without the paired engaged part 4 may be disposed.

### INDUSTRIAL APPLICABILITY

The present invention can be used for a fan and a fan-equipped garment.

### REFERENCE SIGNS LIST

1A . . . fan, 2 . . . case body, 20 . . . front case part, 21 . . . rear case part, 21a . . . ventilation port, 21b . . . peripheral edge, 21c . . . back surface, 21d . . . locking part actuation space, 22 . . . cylindrical part, 22a . . . ventilation port, 22b . . . motor case, 22c . . . fitting recess, 23 . . . flange, 23a . . . end face, 3 . . . engaging tip (engaging means), 30 . . . tongue-shaped part, 31 . . . engaging part, 31a . . . protruding portion, 31b . . . recessed portion, 31c . . . guide surface, 32 . . . fixed end, 33 . . . slit, 34 . . . free end, 4 . . . engaged part (engaged means), 40a . . . recessed portion, 40b . . . protruding portion, 40c . . . guide surface, 5 . . . locking part (locking means), 6 . . . locked part (locked means), 60 . . . guide portion, 10 . . . fan-equipped garment, 11 . . . garment body, 200 . . . mounting member, 200a . . . protrusion.

1. A fan comprising a case body that includes:
a motor case to which a motor for rotating an impeller is attached;
a first case part; and
a second case part that is detachably attached to the first case part,
wherein:
the first case part includes:
a cylindrical part;
a flange that protrudes outward from an outer circumference of the cylindrical part; and
an engaging tip that restricts a relative movement between the first case part and the second case part along a circumferential direction of the flange;
the second case part includes an engaged part that restricts the relative movement between the first case part and the second case part along the circumferential direction of the flange;
the engaging tip includes:
a tongue-shaped part that is flexible, extends along the circumferential direction of the flange, and has one end that is a fixed end with respect to the flange and another end that is a free end; and
an engaging part that is disposed at the free end of the tongue-shaped part and includes a protruding portion protruding from a surface of the flange facing the second case part and a recessed portion recessed with respect to the protruding portion, the protruding portion and the recessed portion being aligned along the circumferential direction of the flange; and
the engaged part is engaged with the engaging part and includes:
a recessed portion recessed with respect to a back surface of the second case part facing the flange; and
a protruding portion protruding with respect to the recessed portion, the protruding portion and the recessed portion being aligned along a circumferential direction of the second case part.

2. The fan according to claim 1, wherein
the first case part includes a locking part that restricts a relative movement between the first case part and the second case part along an axial direction of the cylindrical part;
the second case part includes a locked part that restricts the relative movement between the first case part and the second case part along the axial direction of the cylindrical part; and
when the first case part and the second case part relatively move along the circumferential direction of the flange to a position at which the engaging part and the engaged part are engaged with each other, the locking part is locked to the locked part.

3. The fan according to claim 1, wherein the free end of the tongue-shaped part is disposed downstream of a direction of an engagement between the engaging part and the engaged part caused by the relative movement between the front case part and the rear case part along the circumferential direction of the flange.

4. The fan according to claim 1, wherein;
the engaging part includes a guide surface that bends the tongue-shaped part by being pressed by the engaged part; and
the engaged part includes a guide surface that bends the tongue-shaped part by pressing the engaging part.

5. The fan according to claim 1, further comprising a mounting member that mounts the case body to a target body.

6. The fan according to claim 5, wherein the tongue-shaped part is exposed on a back surface of the flange and contacts the target body to which the case body is mounted by the mounting member.

7. A fan-equipped garment comprising:
the fan according to claim 1; and
a garment body that covers at least a portion of a body of a wearer.
